(19) United States
(12) Patent Application Publication
(10) Pub. No.: US 2012/0162885 A1
(43) Pub. Date: Jun. 28, 2012

(54) INFORMATION PROCESSING APPARATUS

(75) Inventors: Akira IWAMOTO, Osaka (JP); Masaru FURUJIKU, Osaka (JP); Yoshinari MATSUYAMA, Osaka (JP)

(73) Assignee: PANASONIC CORPORATION, Osaka (JP)

(21) Appl. No.: 13/331,770

(22) Filed: Dec. 20, 2011

(30) Foreign Application Priority Data
Dec. 22, 2010 (JP) 2010-286267

(51) Int. Cl. G06F 1/16

(52) U.S. Cl. 361/679.4

(57) ABSTRACT

When a peripheral device is connected to an information processing apparatus, the peripheral device is contained without protruding from the information processing apparatus, and therefore, the peripheral device and the information processing apparatus are protected. A recess is provided in a side surface of a first housing and a USB port is disposed within the recess, and thus, the USB device connected to the USB port can be prevented from significantly protruding from the first housing. Moreover, in the case of a USB device with a reduced-size main body portion, the main body portion can be contained in the recess without protruding from the first housing. Accordingly, a situation in which a user snags his/her clothing or the like on the USB device can be avoided, and thus, damage to the USB device or a notebook computer can be avoided.

### BACKGROUND OF THE INVENTION

1. Field of the Invention

The present invention relates to an information processing apparatus.

2. Description of Related Art

Many information processing apparatuses such as notebook computers are equipped with various types of ports such as USB (universal serial bus) ports provided on side surfaces and the like of their housings. Moreover, in recent years, USB modules, such as memory modules and antenna modules, that are connectable to USB ports have been made available

U.S. 2004/0252472A1 discloses an information device equipped with a connection port. A peripheral device can be connected to the connection port.

However, with the configuration disclosed in U.S. 2004/0252472A1, in a state in which a peripheral device is connected to the connection port, the peripheral device protrudes from the information device, and a user may snag his/her clothing or the like on the peripheral device. If the user snags his/her clothing or the like on the peripheral device, then the peripheral device or the information device may be damaged.

### SUMMARY OF THE INVENTION

An information processing apparatus disclosed in the present application includes a housing, a recess formed in one principal surface of the housing, and a connection port that is disposed in the recess and to which a peripheral device can be connected, wherein the recess can contain a main body portion of the peripheral device connected to the connection port.

According to the disclosure of the present application, when the peripheral device is connected to the information processing apparatus, the peripheral device is contained without protruding from the information processing apparatus, and thus, the peripheral device and the information processing apparatus can be protected.

### BRIEF DESCRIPTION OF THE DRAWINGS

FIG. 1 is a perspective view of a notebook computer.

FIG. 2 is a plan view of a first housing.

FIG. 3 is a perspective view of a USB device.

FIG. 4 is an enlarged cross-sectional view taken along line Z-Z in FIG. 2.

FIG. 5 is an enlarged side view as seen in a direction indicated by arrow D in FIG. 2.

FIG. 6 is an enlarged cross-sectional view showing a state in which a USB device is connected to a USB port.

FIG. 7 is an enlarged side view showing a state in which the USB device is connected to the USB port.

FIG. 8 is an enlarged cross-sectional view of a recess and a USB port of Variation 1.

FIG. 9 is an enlarged side view of the recess and the USB port of Variation 1.

FIG. 10 is a plan view of a first housing of Variation 2.

FIG. 11 is a cross-sectional view taken along line Z-Z in FIG. 10.

FIG. 12 is a cross-sectional view taken along line Z-Z in FIG. 11.

### DETAILED DESCRIPTION OF THE INVENTION

### Embodiment

### 1. Configuration of Information Processing Apparatus

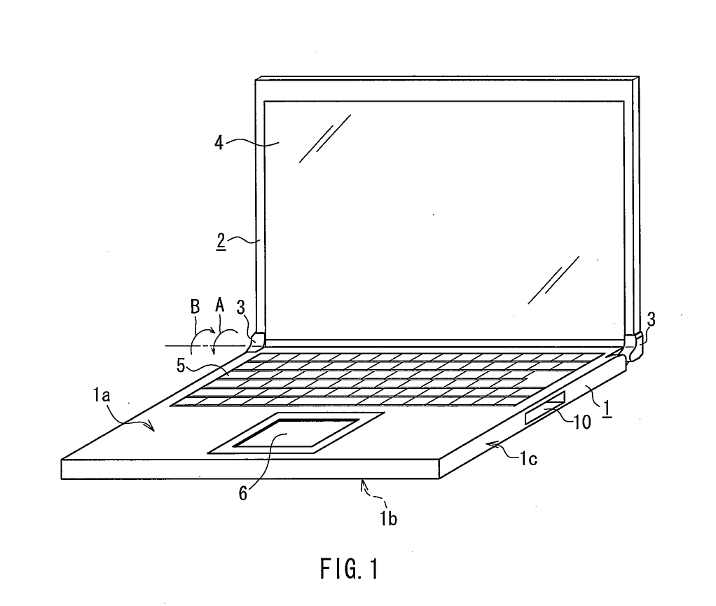

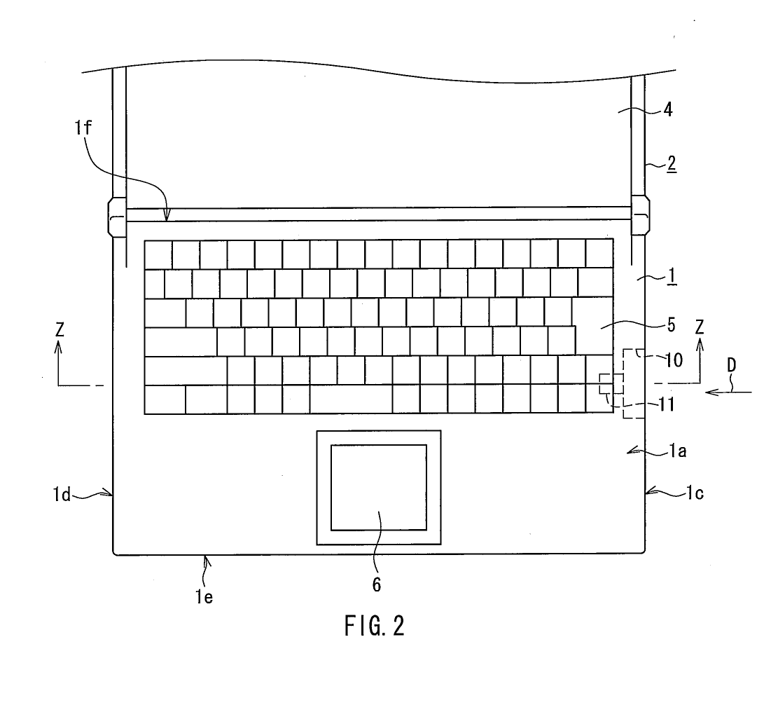

FIG. 1 is a perspective view showing an external configuration of a notebook computer according to an embodiment of the present invention. FIG. 2 is a plan view of a first housing 1 of the notebook computer. Although a notebook computer is used as an example of the information processing apparatus in the present embodiment, any apparatus that is equipped with at least a connection port to which a peripheral device can be connected can be used, and, for example, a desktop computer may be used. Moreover, although a USB device is used as an example of the peripheral device in the present embodiment, the interface with the notebook computer is not limited to USB.

As shown in FIGS. 1 and 2, the notebook computer includes the first housing 1 and a second housing 2. The first housing 1 houses a circuit board on which various types of electrical elements are mounted, a hard disk drive, and the like. The second housing 2 is provided with a display panel 4. The display panel 4 can be implemented with, for example, a liquid crystal display panel. The first housing 1 and the second housing 2 are supported by a hinge portion 3 such that these housings can swing relative to each other. Therefore, the notebook computer can be changed between a first state shown in FIG. 1 and a second state in which the second housing 2 has been swung from the first state in a direction indicated by arrow A and the display panel 4 and a keyboard 5 are facing each other. The hinge portion 3 includes a rotation shaft that supports the first housing 1 and the second housing 2 such that the housings can swing in the direction indicated by arrow A or B. The keyboard 5 and a pointing device 6 are provided on a top surface 1a of the first housing 1. A side surface 1c of the first housing 1 is provided with a recess 10. A USB port 11 is provided inside the recess 10.

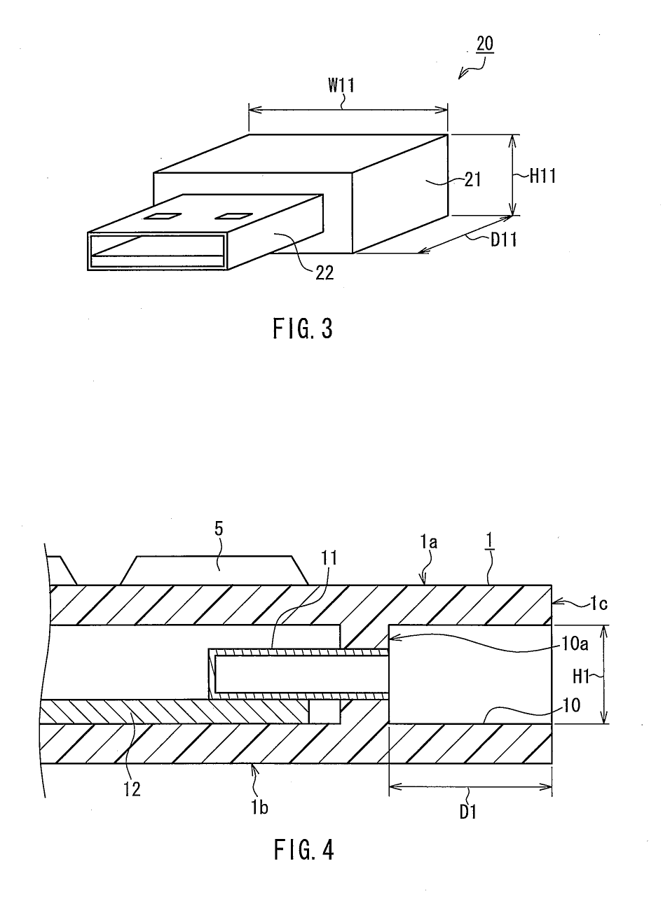

FIG. 3 is a perspective view of an example of a USB device that can be detachably attached to the USB port 11. As shown in FIG. 3, the USB device 20 includes a main body portion 21 and a connector 22. The main body portion 21 houses an electrical element and the like. When a USB device that is capable of storing various types of data is used as the USB device 20 of the present embodiment, the main body portion 21 houses a storage element such as a semiconductor memory. The connector 22 is electrically connected to an electrical element housed in the main body portion 21. The connector 22 is electrically connectable and mechanically attachable to the USB port 11. It should be noted that the USB device 20 is not limited to a device having a memory function that can store various types of data and also may be a USB device or the like that incorporates an antenna module compatible with wireless LANs (local area networks) or the like. In FIG. 3, a dimension W11 indicates the width dimension of the main body portion 21, a dimension H11 indicates the height dimension of the main body portion 21, and a dimension D11 indicates the depth dimension of the main body portion 21. In recent years, small USB devices whose dimensions W11, H11, and D11 are each about 10 mm have been made available.

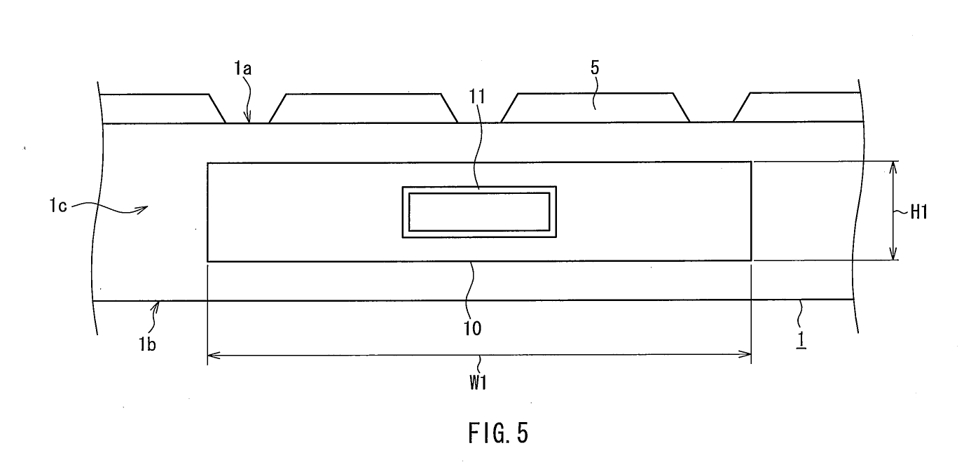

FIG. 4 is an enlarged cross-sectional view showing the recess 10 in FIG. 2 and the vicinity thereof including the USB port 11 (taken along line Z-Z). FIG. 5 is an enlarged side view showing the vicinity of the recess 10 in the side surface 1c of the first housing 1, as seen in a direction indicated by arrow D in FIG. 2.

The recess 10 has a space that can accommodate at least a USB device. The recess 10 has a volume that can accommodate, for example, the main body portion 21 of the USB device 20 shown in FIG. 3. Specifically, a depth dimension D1 (the distance from the side surface 1c of the first housing 1 to a back surface 10a shown in FIG. 4), a height dimension H1 (see FIGS. 4 and 5), and a width dimension W1 (see FIG. 5) of the recess 10 and the depth dimension D11, the height dimension H11, and the width dimension W11 of the main body portion 21 of the USB device 20 shown in FIG. 3 are set so as to have the following relationship:

D11≦D1

H11<H1

W11<W1.

It should be noted that the height dimension H1 and the width dimension W1 of the recess 10 are set to be larger than the height dimension H11 and the width dimension W11 of the main body portion 21 of the USB device 20, as represented by “H11<H1” and “W11<W1”, because this allows the user to hold the main body portion 21 when attaching/detaching the USB device 20 to/from the USB port 11.

Moreover, it is preferable that the width dimension W11 and the height dimension H11 of the recess 10 are set to dimensions that are as large as possible so that, when removing the USB device 20 from the USB port 11, the user easily can insert his/her fingers between the USB device 20 and the recess 10 and hold the main body portion 21 of the USB device 20 with the fingers. The dimension W1 is preferably set to 50 mm or more when, for example, the dimension W11 is 10 mm. The dimension H1 is preferably set to 20 mm or more when, for example, the dimension H11 is 10 mm. Since the recess 10 is open, D11 may be equal to D1 as expressed in the above-described relation.

The USB port 11 is a port conforming to the USB standard. For example, the USB device 20 shown in FIG. 3 can be detachably attached to the USB port 11. The USB port 11 is electrically connected and mechanically fixed to a circuit board 12 housed in the first housing 1. The USB port 11 has an opening for removably inserting the connector 22 (see FIG. 3), and this opening is exposed to the inside of the recess 10.

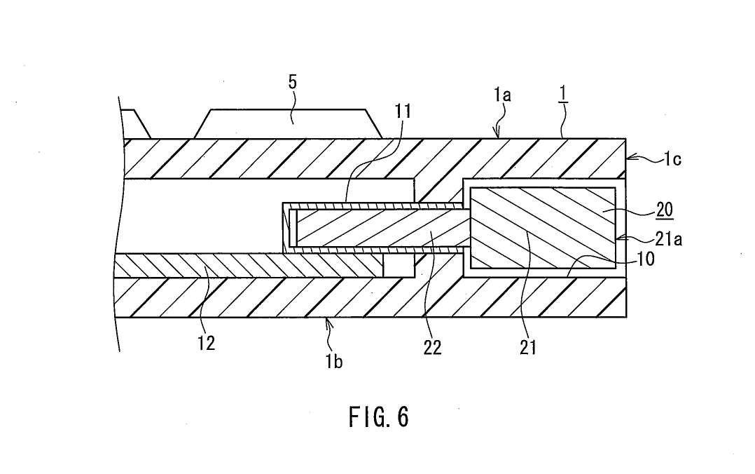

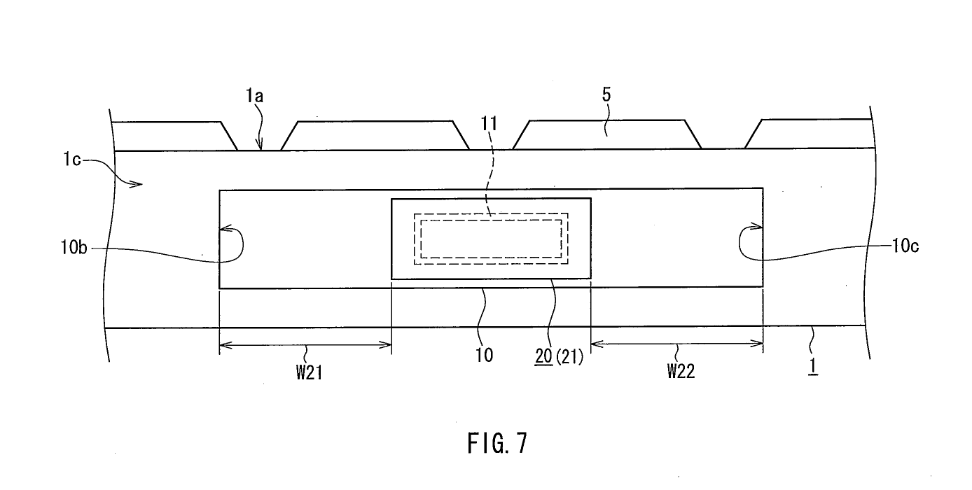

FIG. 6 is a cross-sectional view showing a state in which the USB device 20 has been connected to the USB port 11. FIG. 7 is a side view showing a state in which the USB device 20 has been connected to the USB port 11, as seen in the direction indicated by arrow D in FIG. 2. As shown in FIGS. 6 and 7, in the state in which the connector 22 of the USB device 20 has been connected to the USB port 11, the main body portion 21 is located within the recess 10. Specifically, an end surface 21a of the main body portion 21 does not protrude from the side surface 1c of the first housing 1 and is located within the recess 10. It should be noted that the end surface 21a of the main body portion 21 may be provided in such a position that the end surface 21a is flush with the side surface 1c of the first housing 1.

Moreover, as shown in FIG. 7, the width dimension W1 (see FIG. 5) of the recess 10 is set to such a value that a gap W21 can be created between the USB device 20 connected to the USB port 11 and a left inner surface 10b, and a gap W22 can be created between the USB device 20 and a right inner surface 10c. The gaps W21 and W22 are provided in order that when the user attaches/removes the USB device 20 to/from the USB port 11, the user inserts a finger (e.g., a first finger) between the main body portion 21 of the USB device 20 and the left inner surface 10b of the recess 10 and a finger (e.g., a second finger) between the main body portion 21 and the right inner surface 10c to hold the main body portion 21 of the USB device 20. Therefore, the dimensions of the gaps W21 and W22 can be set to any dimensions that allow at least a user's finger (e.g., a first finger or a second finger, whichever is the greater) to be inserted in the gaps. Although the thickness of human fingers varies among individuals, it is preferable to set the dimension of each of the gaps W21 and W22 to about 20 mm.

### 2. Effects of Embodiment, Etc.

According to the present embodiment, the recess 10 is provided in the side surface 1c of the first housing 1 and the USB port 11 is disposed within the recess 10, and thus, the USB device 20 can be prevented from significantly protruding from the first housing 1 when connected to the USB port 11. Moreover, in the case of the USB device 20 with the reduced-size main body portion 21, the USB device 20 can be contained in the recess 10 without the main body portion 21 protruding from the first housing 1. Accordingly, a situation in which the user snags his/her clothing on the USB device 20 can be prevented, and damage to the USB device 20 or the notebook computer can be avoided.

Moreover, even if the main body portion 21 of the USB device 20 has a large depth dimension D11, the amount by which the main body portion 21 protrudes from the side surface 1c can be suppressed to a smaller amount than that in the case where a USB device is connected to a USB port provided on the side surface 1c. Accordingly, the possibility of the clothing or the like of the user snagging on the USB device 20 protruding from the first housing 1 can be reduced.

According to the present embodiment, the USB port 11 is provided within the recess 10, and thus, the notebook computer (in the second state) can be put smoothly into a bag or the like with the USB device 20 still connected to the USB port 11. In other words, since the USB device 20 connected to the USB port 11 does not significantly protrude from the first housing 1, the USB device 20 is unlikely to get caught on a seam or the like on the inside of the bag when the notebook computer in the second state is put into the bag or the like. Accordingly, the notebook computer can be put smoothly into the bag or the like with the USB device 20 still connected to the USB port 11.

That is to say, according to the disclosure of the present application, assuming that, for example, a USB device is used as the peripheral device, a main body portion of the USB device can be accommodated in the recess provided in one principal surface of the housing of an electronic device. Since not only the connector connected to the USB port but also at least a part of the main body portion of the USB device is contained in the recess, a situation in which a strong external force is applied to a connector portion of the USB device effectively can be avoided, and thus, damage to the USB device can be avoided.

It should be noted that, although a configuration in which the USB port 11 is provided in the recess 10 has been described in the present embodiment, any configuration can be adopted as long as at least a connecting portion to which a device composed of a single housing can be connected is provided in the recess 10. For example, a slot to which a card conforming to the PCMCIA standard (Personal Computer Memory Card International Association) can be detachably attached may be provided in the recess 10.

Moreover, the recess 10 and the USB port 11 are not necessarily provided in the side surface 1c of the first housing 1 and may be provided in a side surface 1d, a front surface 1e, or a rear surface 1f of the first housing 1.

The USB port 11 is not necessarily provided in the back surface 10a of the recess 10 and may be provided in the left inner surface 10b or the right inner surface 10c (see FIG. 7 for both of these surfaces).

Moreover, in addition to the USB port 11 within the recess 10, preferably, a USB port also is provided on the side surface 1c. With such a configuration, in the case of a USB device that will be frequently attached/detached like a mouse, the greater ease of attachment/detachment operations can be attained by connecting the USB device to the USB port on the side surface 1c.

Variations with respect to the present embodiment will be disclosed below.

### Variation 1

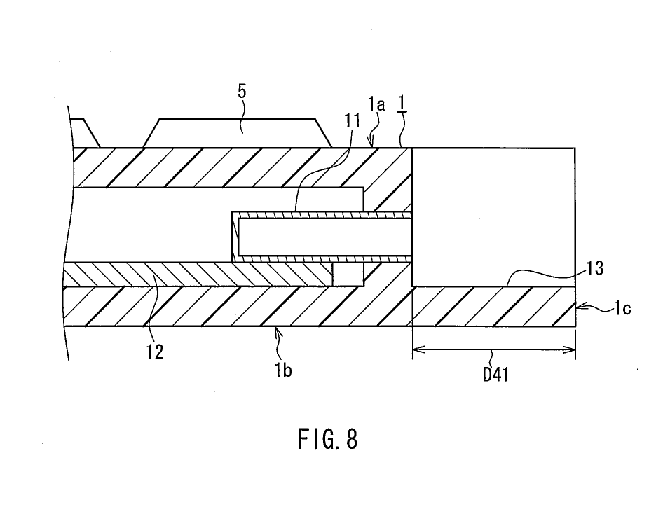

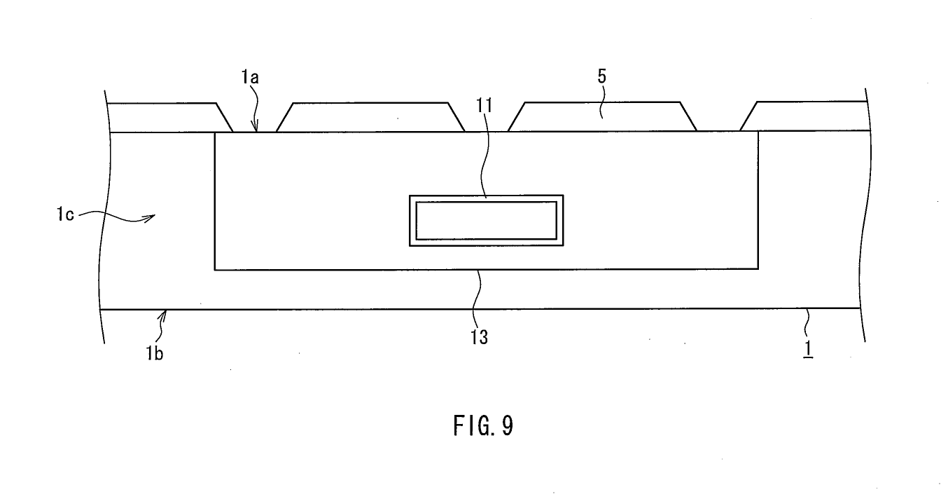

FIG. 8 is a cross-sectional view of an information processing apparatus according to Variation 1. FIG. 9 is a side view of the information processing apparatus shown in FIG. 8, as seen in the direction indicated by arrow D. The information processing apparatus shown in FIGS. 8 and 9 is different from the information processing apparatus shown in FIG. 4 and the like in that the top surface la side of a recess 13 is open.

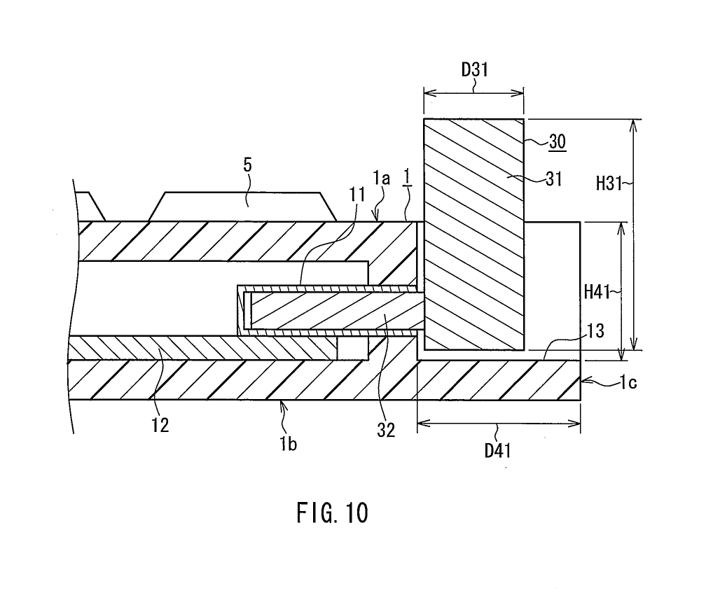

FIG. 10 is a cross-sectional view showing a state in which a USB device 30 has been connected to the USB port 11 shown in FIG. 8. The USB device 30 includes a main body portion 31 and a connector 32. The main body portion 31 has a height dimension H31 that is higher than the height dimension of H11 of the USB device 20 shown in FIG. 3. The height dimension of H31 of the main body portion 31 is higher than a height dimension of H41 of the recess 13. A depth dimension D31 of the main body portion 31 is smaller than a depth dimension D41 of the recess 13. Since the top surface 1a side of the recess 13 is open, the USB device 30 whose height dimension H31 is higher than the height dimension H41 of the recess 13 can be connected to the USB port 11 as shown in FIG. 10. Here, the configuration in which the USB device 30 protrudes from the top surface 1a of the first housing 1 is preferable, because the resulting possibility of the clothing or the like of the user being snagged can be reduced when compared to a configuration in which the USB device 30 protrudes from the side surface 1c.

It is further preferable to set the height dimension of H31 of the main body portion 31 of the USB device 30 to a smaller value than the height dimension of H41 of the recess 13, because the resulting main body portion 31 can be prevented from protruding from the recess 13.

### Variation 2

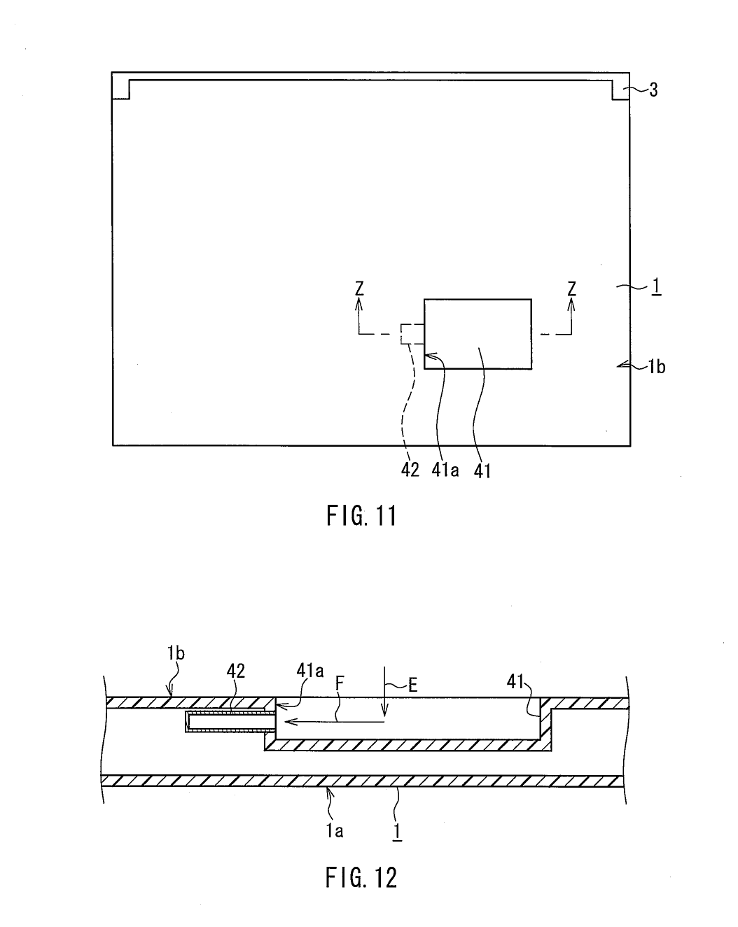

FIG. 11 is a plan view of an information processing apparatus according to Variation 2. FIG. 12 is a cross-sectional view taken along line Z-Z in FIG. 11.

As shown in FIGS. 11 and 12, a recess 41 is formed in an under surface 1b of the first housing 1. A USB port 42 is disposed in an inner surface 41a of the recess 41. When a USB device is to be connected to the USB port 42, the USB device is put into the recess 41 as indicated by arrow E and then slid toward the USB port 42 side as indicated by arrow E

With such a configuration, the USB device can be disposed in the recess 41 by connecting the USB device to the USB port 42.

It should be noted that since the recess 41 is formed in the under surface 1b of the first housing 1, it is preferable that the USB device to be connected to the recess 41 is a USB device that will be less frequently attached/detached to/from the USB port 42.

Since the recess 41 is formed in the under surface 1b of the first housing 1, there is a fear that a contaminant such as dust might intrude into the recess 41. For this reason, it is preferable to adopt a configuration in which the recess 41 can be closed by a lid (not shown).

The notebook computer of the present embodiment is an example of the information processing apparatus. The first housing 1 of the present embodiment is an example of the housing. The recesses 10, 13, and 41 of the present embodiment are examples of the recess. The USB ports 11 and 42 of the present embodiment are examples of the connection port. The USB devices 20 and 30 of the present embodiment are examples of the peripheral device.

The disclosure of the present application is useful for an information processing apparatus.

What is claimed is:

1. An information processing apparatus comprising:
a housing;
a recess formed in a principal surface of the housing; and
a connection port that is disposed in the recess and to which a peripheral device can be connected,
wherein the recess can contain a main body portion of the peripheral device connected to the connection port.

2. The information processing apparatus according to claim 1,
wherein the recess can contain the peripheral device connected to the connection port in such a manner that the peripheral device does not protrude from the principal surface.

3. The information processing apparatus according to claim 1,
wherein the recess is formed continuously in the principal surface and a surface contiguous to the principal surface of the housing.

4. The information processing apparatus according to claim 1, comprising:
an input portion that accepts an input operation by a user,
wherein the principal surface is a surface of the housing on an opposite side from a surface on which the input portion is provided.
